(19) United States
(12) Patent Application Publication
(10) Pub. No.: US 2011/0305624 A1
(43) Pub. Date: Dec. 15, 2011

(54) METHOD FOR PRODUCTION OF LITHIUM CARBONATE

(76) Inventors: Abraham Sadan, Park City, UT (US); Stanley C. Johnson, Taylorsville, UT (US); Wells B. Johnson, Pleasant Grove, UT (US)

(21) Appl. No.: 13/154,355

(22) Filed: Jun. 6, 2011

Related U.S. Application Data
(60) Provisional application No. 61/354,841, filed on Jun. 15, 2010.

(51) Int. Cl. C01D 15/08

(52) U.S. Cl. 423/421

(57) ABSTRACT

The present invention relates to a process for producing lithium carbonate from brine by precipitating calcium ions by reacting brine with schoenite to yield carnallite, Gypsum, and lithium, wherein the brine comprises of salts of one or more of sodium, magnesium, and potassium chloride and then reacting that lithium chloride solution with sodium carbonate to give lithium carbonate.

### CROSS-REFERENCES TO RELATED APPLICATION

This application claims priority to U.S. Provisional Patent Application No. 61/354,841 entitled “Lithium Chloride and or Lithium Carbonate Production from a Brine Containing Calcium and from a Brine being Calcium Free,” filed Jun. 15, 2010 for Abraham Sadan et al., which is incorporated herein by reference.

### BACKGROUND OF THE INVENTION

1. Field of the Invention

This invention relates to a method of production of lithium, and more particularly relates to a method of production of lithium carbonate from evaporation ponds.

2. Description of the Related Art

Lithium is found distributed in numerous minerals due to its chemical reactivity. Apart from Lithium, sources such as mineral Spodumene, Petalite, LiAl (Si₄O₁₀), and Lepidolite, other sources for obtaining lithium, have grown in importance in the last few decades. Lithium is generally found in the brines of salt mines, geysers, and salt lakes, in the form of chloride, sulfate, borate, double potassium and magnesium. Lithium content in brines varies typically from 0.02% as in the brines found in Clayton Valley in Nev., USA, to 0.2% at the Atacama Salt Mines in Chile. By evaporation of the brine in fractionated crystallization ponds, up to 6% lithium by weight can be extracted. Besides lithium, natural brines also contain other elements such as potassium, sodium, magnesium, iron, boron, bromine, chlorine, as well as nitrates, chlorides, sulfates, and carbonates. Each brine must be treated in a particular manner according to its composition.

Generally, the brines are concentrated before processing by solar evaporation to increase the lithium content and also to precipitate other salts that could have commercial value such as potassium chloride, sodium chloride, potassium sulfate, sodium sulfate or boric acid, as well as other double salts like silvinite, carnallite, bishoffite, schoenite, kainite, glasserite, etc. Also, natural brines are richer in sulfates and chlorides, especially the latter.

Lithium carbonate finds its major industrial application in Lithium batteries and at the same time is also used actively in the high quality ceramics industry, in which lithium carbonate of high purity is desired. However existing processes of producing Lithium Carbonate from brine do not yield high quality lithium carbonate and at the same time use expensive techniques and raw materials during the production process from brine. For instance, the existing lithium carbonate extraction/production processes use sodium sulphate or sodium hydroxide for removing components such as magnesium, and calcium, which make the extraction process costly thereby lowering the commercial viability of the produced lithium carbonate.

U.S. Pat. No. 5,993,759 discloses a process of producing lithium carbonate from a brine by removing the boron from the brine, diluting the boron-free brine, removing magnesium from the diluted brine, and adding sodium carbonate to thereby precipitate lithium carbonate.

There is a need for a more cost effective, faster, and efficient process for extraction and production of lithium carbonate, and the present invention beneficially teaches a unique method of accomplishing the same.

### SUMMARY OF THE INVENTION

From the foregoing discussion, it should be apparent that a need exists for a method of producing lithium carbonate from brine. The present invention has been developed in response to the present state of the art; and, in particular, in response to the problems and needs in the art that have not yet been fully solved by currently available methods and that overcome many or all of the above-discussed shortcomings in the art. Accordingly, the present invention has been developed to provide a method of producing lithium carbonate using brine, the steps of the method comprising:

adding water to a slurry tank; adding ECM to the slurry tank to create a slurry within the slurry tank; adding schoenite to the slurry tank; allowing gypsum to precipitate out of the slurry; allowing potassium and magnesium to form carnallite; allowing the carnallite to precipitate out to leave a solution comprising lithium chloride, sodium chloride, and potassium chloride; adding sodium carbonate to the solution; and allowing lithium carbonate to form and precipitate out of the solution.

In some embodiments, the method further comprises the steps of filtering the lithium carbonate by: adding the lithium carbonate to centrifuge; and washing out residue comprising sodium chloride and potassium chloride from the lithium carbonate using water while the centrifuge is in motion.

Other embodiments further comprise the steps of measuring levels of potassium in the slurry; and adding potassium to the slurry in response to the slurry's potassium levels falling below a threshold sufficient to bond with magnesium in the slurry to produce carnallite.

Other embodiments further comprising a step of drying the lithium carbonate, while still further embodiments comprise a step of moving the slurry to one of a settling tank and a centrifuge.

The method may further comprise moving the slurry to one of a settling tank and a centrifuge. The said brine may not contain said calcium chloride. In some embodiments, any sulphate containing salt obtained from the Great Salt Lake brine can be used for precipitating calcium ions.

A second method of producing lithium carbonate using electrolytic excess cell melt (ECM) is disclosed, the steps of the method comprising: reacting the ECM with water and one of schoenite, kainite and epsomite (collectively the “solution”) to precipitate out of the solution a mineral containing CaCl2 in solid form; removing the precipitated gypsum from the solution, thus increasing the concentration of LiCl in the solution; and reacting LiCl in the solution with sodium carbonate to precipitate lithium carbonate.

The water may be derived from the Great Salt Lake or a public utility company. The method may further comprise adding KCl to the solution. Alternatively, the method may further comprise decomposing carnallite to provide KCl, and adding KCL to the solution.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a flow chart diagram of a method of producing lithium carbonate in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. The apparatus modules recited in the claims may be configured to impart the recited functionality to the apparatus.

The production of lithium from a plant that produces magnesium metal is quite unique. This is currently possible only at the U.S. Magnesium Plant located on the shores of the Great Salt Lake. The feed for this U.S. Magnesium Plant is obtained by evaporating lake brine in large solar evaporation ponds. The Great Salt Lake brine comprises the following minerals, SO₄, K, Li, Br, Na, Mg and Cl. The lake brine contains approximately 0.002 percent (%) lithium. By the time that the brine goes through its yearly evaporation cycle, the lithium concentration is increased to 0.06 percent. The brine, in accordance with the present invention, is sent to a plant where it goes through a series of chemical and thermal processes to convert the brine into molten electrolyte as feed for electrolytic cells. The molten electrolyte in the electrolytic cells reaches a concentration of 25% lithium chloride in the cells as magnesium is removed from the cell. The molten electrolyte comprising concentrated lithium chloride from an electrolytic cell is defined as ECM (excess cell melt) for the purposes of this patent.

It is necessary to maintain the electrolyte in the cell(s) at a constant concentration. In order to accomplish this, it is necessary to discard from the cell(s), on a given schedule, some of the electrolyte. This discarded electrolyte, or ECM, in one embodiment, contains approximately 25% lithium chloride. The process for extracting lithium from this ECM is discussed further below.

The present disclosure provides a process for production of lithium carbonate using brine. Brine of the present disclosure may, or may not, comprise calcium and the disclosed process for production of lithium carbonate would be applicable to both types of brines. It is known that a chloride brine, apart from having calcium salts, also comprises of salts of sodium, magnesium, potassium, and lithium. Furthermore, the solubility of calcium chloride and lithium chloride is very high, wherein the solubility for both the salts can reach to about 50% allowing other chloride salts such as NaCl, KCl, and MgCl₂, having low solubility, to precipitate.

It is an object of the present invention to provide a method for the recovery of lithium chloride from brines or salts containing calcium. The compound schoenite (K₂SO₄.MGSO₄.6H₂O) is used as the source of sulfate ion to precipitate the calcium from solution as gypsum (CaSO₄.2H₂O). The magnesium ion is removed from the lithium chloride brine by precipitating it as carnallite (MgCl₂.KCl.6H₂O). The schoenite salt is readily available from solar evaporation ponds such as those in use at the Magnesium Plant located on the shores of the Great Salt Lake.

The chemical equation for the schoenite reaction with a brine containing magnesium and calcium is as follows: MgSO₄.K₂SO₄.6H20+MgCl₂+2(CaCl₂)--------2(CaS0₄.2H₂0)+2(NgCl₂.KCl.6H₂O).

The recover of lithium from a calcium free brine may be accomplished by solar evaporation in solar evaporation ponds. The brine from which most Lithium is produced comes from Chili, Argentina, Bolivia, Tibet and the US. The brines of these sources contain little or no calcium. The lithium from these calcium free brine may be recovered by solar evaporation. This is possible because the solubility of LiCl reaches concentrations of approximately 40% to 60%. The solubility of most other salts, such as NaCl, KCl, MgCl₂, MgCl₂.KCl.6H₂O, MgCl₂.6H₂O, MgCl₂.LiCl.6H₂O are significantly lower in concentration and will precipitate of the solution. This process is reference to as the “salting out” process. However, calcium chloride is the exception of the rule and has a solubility of 45% to 50% similar to that of LiCl and must be removed by using the Schoenite process to precipitate the calcium as gypsum before precipitating as Li₂CO₃ by the addition of Na₂CO. To prevent the mineral (MgCl₂.LiCl.6H₂O) which would increase lithium losses significantly, from precipitating at the high lithium concentration, the additional Potassium must be added to the lithium brine causing carnallite to precipitate (MgCl₂.KCl.6H₂O) in lieu MgCl₂.LiCl.6H₂O).

The Lithium from calcium free brines may be recovered by solar evaporation. This is possible because the solubility of Licl reaches concentrations of approximately 45-60%. The solubility of most other salts such as Nacl, KCl, MgCl₂, MgCl₂.KCl.6H₂O, MGc12.6H₂O, MgCl₂.LiCl.6H₂O are significantly lower in concentration and will precipitate out of solution. This process is referred to as the “salting out” process. However, CaCl₂ is an exception to the rule and has a solubility of 45-50% similar to that of LiCl and must be removed by using the Schoenite process to precipitate the calcium as gypsum before precipitating the lithium as Ll₂CO₃ by the addition of Na₂CO₃. To prevent the mineral MgCl₂.LiCl.6H₂O which would increase lithium losses significantly from precipitating at these high lithium concentrations, additional potassium must be added to the lithium brine causing carnallite to precipitate MgCl₂.KCl.6H₂O in lieu of MgCl₂.Licl.6H₂O.

Lithium may be recovered from a solution containing calcium and magnesium by removing the calcium by adding a compound containing sulfate. The sulfate reacts with the calcium to produce gypsum. The typical process for the removal of magnesium from solution is by adding Caustic (NaOH) which will precipitate the magnesium ion as MgSOH₂. Both magnesium and calcium must be removed from a solution containing lithium before the Lithium can be recovered from the solution. Once the magnesium and calcium are precipitated from solution, then the lithium is precipitated out of the solution by the addition of Na₂CO₃ to produce Li₂CO₃.

The cost of using Na₂SO₄ and NaOH to precipitate the magnesium and calcium is very expensive compared to using schoenite (MgSO₄.K₂SO₄.6H₂O). It is an object of this invention to provide a more cost-effective means of precipitating the necessary minerals.

As used herein, term “salting out” denotes the solidification and/or crystallization of a newly formed mineral in a slurry, ECM, or solution, and its tendency to fall to the bottom of a slurry vessel containing a slurry, ECM or solution. A slurry tank, or slurry vessel, comprises any tank, container or vessel used for storing brine or ECM, natural or manmade.

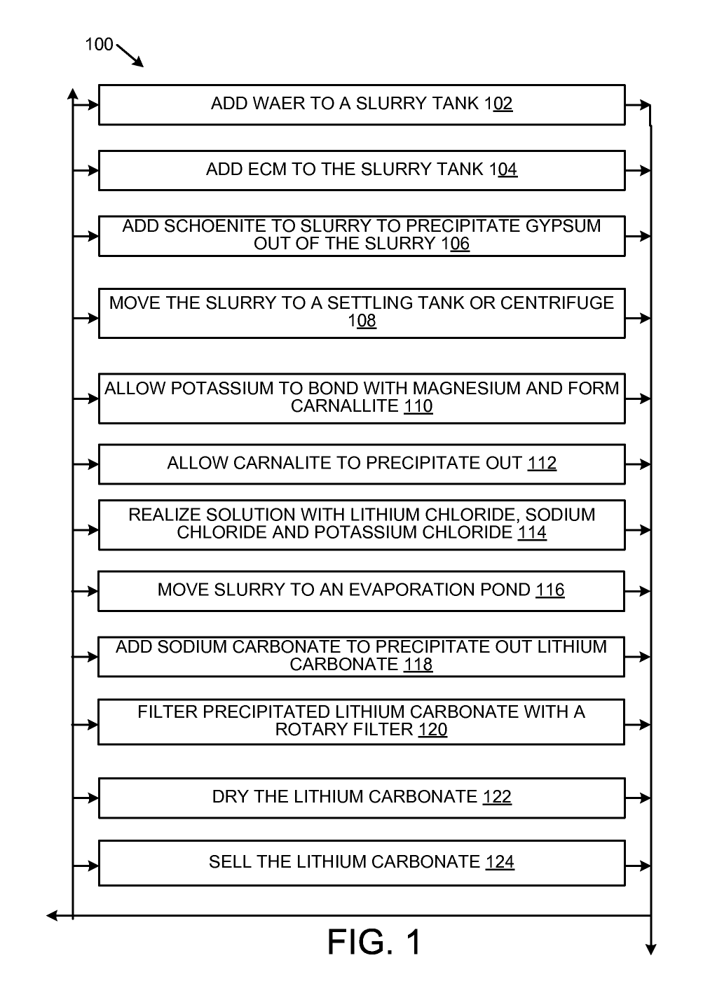

FIG. 1 is a flow diagram 100 illustrating steps involved in production of lithium carbonate as an embodiment of the present invention. In an embodiment of the present disclosure for production of lithium carbonate, in brines having both LiCl and CaCl₂, Ca ions can be precipitated by reaction of the brine with a sulphate containing salt. Minerals of hydrate double salts including Schoenite Mg₂SO₄.K₂SO₄.6H₂O can be used for precipitation/removal of Ca ions. Schoenite includes two moles of SO₄ to one mole of Mg and two moles of K to one mole of Mg making it rich in SO₄ to precipitate Ca as CaSO₄.2H₂O (gypsum) whereas the richness in K allows efficient precipitation of Mg as Carnallite MgCl₂.KCl.6H₂O. As gypsum has very low solubility, after the reaction, gypsum so formed precipitates, leaving behind LiCl and NaCl in the brine. LiCl can then be reacted with Na₂CO₃ to precipitate Li₂CO₃. The sodium salt is left in the solution itself.

FIG. 1 shows the production of lithium carbonate, wherein brine having chloride salts including NaCl, KCl, CaCl₂, MgCl₂, and LiCl is reacted with Schoenite (Mg₂SO₄.K₂SO₄.6H₂O) in a slurry vessel in the presence of H₂O.

In step 102, water is added to a slurry tank, followed by ECM added to the slurry tank, which is mixed with the water in step 104.

In the preferred embodiment, the electrolytic cells are fed molten salt that is produced from the Great Salt Lake Brine. In order to maintain a molten salt bath in the cell of a composition within a constant range, a given amount of salts (ECm) electrolytic excess cell melt must be removed from the cell each day the salt is stored. The amount of ECM removed from each cell is determined by chemical analysis. A typical cell salt analyses is approximately 25% LiCl, 28% calcium carbonate, 15% MgCl₂, 25% NaCl, and 7% KCl. Salt compositions in these approximate proportions are required to maintain efficiency in the cells and keep the magnesium metal floating on top (which is lower in density). It is from the excess cell salt that the lithium chloride is produced.

After moving the solution to a settling pond, as shown in 104, the reaction gives Carnallite (MgCl₂.KCl.6H₂O) and Gypsum (CaSO₄.2H₂O) along with NaCl.

Mg₂SO₄.K₂SO₄.6H₂O+NaCl+KCl+2(CaCl₂)+MgCl₂+LiCl→2(CaSO₄.H₂O)+2(MgCl₂.KCl.3H₂O)+KCl+LiCl+NaCl

Presence of potassium in schoenite ensures no precipitation of bischofite (MgCl₂.6H₂O) or double salt of MgCl₂.LiCl.6H₂O thereby not allowing the precipitation of LiCl which is to be later reacted with Na₂CO₃ to give the desired Li₂CO₃. Even in brines with no Ca ions, presence of Potassium in Schoenite ensures no precipitation of Bischofite (MgCl₂.6H₂O) or double salt of MgCl₂.LiCl.6H₂O. In an embodiment, more KCl can be added after Schoenite for more efficient precipitation of Carnallite leading to further lowering of Mg level in brine.

In an embodiment, instead of using Schoenite for precipitating Ca ions, other sulphate salts such as K₂SO₄ can also be used, for instance Kainite (MgSO₄.KCl.3H₂O) as well as Epsomite (MgSO₄.7H₂O), since all the magnesium will precipitate before the lithium concentration reaches 6% concentration level.

Additionally, any Great Salt Lake brine or solution can be used since the brine contains sulfate. The magnesium ion will precipitate as MgCl₂.6H₂O before the lithium ion concentration reaches saturation level of 6%.

In some embodiments, schoenite is the preferred salt since its potassium level is high enough to bond with MgCl₂ and form carnallite rather than bischofite. Kanite contains lesser potassium ions and is less preferred while epsomite, having no potassium ions, is even less preferred, but each will precipitate calcium out of the gypsum and fulfill an object of the present invention.

Carnallite can be further decomposed to provide KCl that can be recycled to provide for the precipitation of carnallite instead of bischofite.

so long as the salts do not react with carbonate. For instance, Epsomite MgSO₄.7H₂O allows Mg to react with the Carbonate for precipitation of MgCO₃ and hence would not be a good candidate. This would in fact be applicable to all minerals having Mg, as Mg needs to be removed prior to the carbonation step for precipitation of lithium carbonate. Kainite (MgSO₄.KCl.3H₂O) too, being an Mg salt, would not be a preferred option. In another embodiment, any sulphate

| | Ca | Mg | K | Na | Li | Cl | SO4 | H2O | Total |
|---|---|---|---|---|---|---|---|---|---|
| Lithium Mineral | 1,316 | 446 | 554 | 842 | 440 | 8,014 | | | 11,612 |
| Water | | | | | | | | 28,414 | 28,414 |
| MgSO4•K2SO4•6H2O | | 400 | 1,283 | | | | 3,158 | 1,777 | 6,618 |
| NaCl | | | | 520 | | 803 | | | 1,324 |
| Total In | 1,316 | 846 | 1,837 | 1,362 | 440 | 8,817 | 3,158 | 30,191 | 47,968 |
| Gypsum Out | 1,316 | | | | | | 3,158 | 1,184 | 5,658 |
| Solution out | | 846 | 1,837 | 1,362 | 40 | 8,817 | | 29,007 | 42,309 |
| Total out | 1,316 | 846 | 1,837 | 1,362 | 440 | 8,817 | 3,158 | 30,191 | 47,968 |
| Solution out Wt % | | 2.00 | 4.34 | 3.22 | 1.04 | 20.84 | 0.00 | 68.56 | 100.00 |

TABLE 2
Solar Evaporation of the Calcium-free Solution

| | Mg | K | Na | Li | Cl | CO3 | H2O | Total |
|---|---|---|---|---|---|---|---|---|
| Solution In | 846 | 1,837 | 1,362 | 440 | 8,817 | 0 | 29,007 | 42,309 |
| Evaporation | | | | | | | 19,078 | 19,078 |
| Carnallite-NaCl Out | 846 | 1,837 | 1,362 | | 6,246 | | 6,664 | 6,664 |
| LiCl Solution Out | | | | 440 | 2,231 | | 3,265 | 5,936 |

TABLE 3
Carbonation of LiCl Solution for the production of Lithium Carbonate

| | Mg | K | Na | Li | Cl | CO3 | H2O | Total |
|---|---|---|---|---|---|---|---|---|
| LiCl solution In | | | | 440 | 2,231 | | 3,265 | 5,936 |
| Na2CO3 In | | | 1,446 | | | 1,886 | | 3,331 |
| Li2CO3 Out | | | | 340 | | 2,914 | | 3,254 |
| Brine Out | | | 1,446 | 100 | 2,231 | 857 | 3,265 | 7,899 |
| Brine Out in Wt % | | | 18.30 | 1.27 | 28.25 | 10.85 | 41.33 | 100.00 |

containing salt obtained from the great sea lake can be used for precipitating calcium and magnesium ions of brine.

FIG. 1 illustrates the crystallization step wherein the solution so formed in step 104 is crystallized giving out H₂O, KCl, and NaCl. Carnallite and Gypsum salts are precipitated and extracted out. Step 108 illustrates LiCl with 50% concentration being stored in a holding pond reservoir having Sp/Gr 1.45 giving out further H₂O, Step 110 illustrates mixing of LiCl with Na₂CO₃ in a mixing tank which is then filtered at step 112 to finally give out pure lithium carbonate (Li₂CO₃).

LiCl+Na₂CO₃→Li₂CO₃

Lithium carbonate can undergo subsequent steps of drying, bagging, and shipping. In an embodiment, brine after the final step can be recycled to provide the Li₂CO₃ it contains.

A settling tank comprises any manmade or natural reservoir for holding slurry, solution, brine or ECM. In some embodiments of the present invention, the slurry in the slurry tank is moved 108 to settling tank for further processing in accordance with the present invention. In other embodiments, the slurry is not moved.

Potassium may be added 110 to the slurry to bond with the magnesium in the slurry and precipitate out 112 carnallite, after which a solution is left in the slurry vessel or settling tank which comprises lithium chloride, sodium chloride, and potassium chloride.

In various embodiments of the present invention, sodium carbonate is then added 118 to the solution to precipitate out lithium carbonate, which may collected for further processing using means known to those of skill in the art.

This lithium carbonate is filtered with rotary filter or centrifuge and “washed” during filtration to remove impurities, including residue potassium chloride and sodium chloride.

The lithium carbonate is then dried 122 using means known to those of skill in the art and sold 124 on the open market.

### Experimental Examples

The following Tables 1 to 3 depict the material balance of the process

Table 1: The reaction of Lithium-Calcium Solution with Schoenite-NaCl Salt.

Although the present invention has been described with reference to specific details, it is not intended that such details should be regarded as limitations on the scope of the invention, except to the extent that they are included in the claims. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of producing lithium carbonate using brine, the steps of the method comprising:
adding water to a slurry tank;
adding ECM to the slurry tank to create a slurry within the slurry tank;
adding schoenite to the slurry tank;
allowing gypsum to precipitate out of the slurry;
allowing potassium and magnesium to form carnallite;
allowing the carnallite to precipitate out to leave a solution comprising lithium chloride, sodium chloride, and potassium chloride;
adding sodium carbonate to the solution; and
allowing lithium carbonate to form and precipitate out of the solution.

2. The method of claim 1, further comprising filtering the lithium carbonate by:
adding the lithium carbonate to centrifuge; and
washing out residue comprising sodium chloride and potassium chloride from the lithium carbonate using water while the centrifuge is in motion.

3. The method of claim 1, further comprising:
measuring levels of potassium in the slurry; and
adding potassium to the slurry in response to the slurry's potassium levels falling below a threshold sufficient to bond with magnesium in the slurry to produce carnallite.

4. The method of claim 1, further comprising drying the lithium carbonate.

5. The method of claim 1, further moving the slurry to one of a settling tank and a centrifuge.

6. The method of claim 1, further moving the slurry to one of a settling tank and a centrifuge.

7. The method of claim 1, wherein said brine does not contain said calcium chloride.

8. The method of claim 1, wherein any sulphate containing salt obtained from the Great Salt Lake brine can be used for precipitating calcium ions.

9. A method of producing lithium carbonate using electrolytic excess cell melt (ECM), the steps of the method comprising:
reacting the ECM with water and one of schoenite, kainite and epsomite (collectively the “solution”) to precipitate out of the solution a mineral containing CaCl2 in solid form;
removing the precipitated gypsum from the solution, thus increasing the concentration of LiCl in the solution; and
reacting LiCl in the solution with sodium carbonate to precipitate lithium carbonate.

10. The method of claim 9, wherein the water is derived from the Great Salt Lake or a public utility company.

11. The method of claim 9, further comprising adding KCl to the solution.

12. The method of claim 9, further comprising: decomposing carnallite to provide KCl, and adding KCL to the solution.
